(19) United States
(12) Patent Application Publication
(10) Pub. No.: US 2002/0022961 A1
(43) Pub. Date: Feb. 21, 2002

(54) Displaying information on a portable digital device by transmission of a universal resource locator over a short-range radio frequency link

(76) Inventor: Stefan Sepanaho, Summerland, CA (US)

Correspondence Address: TRACY W. DRUCE, KILPATRICK STOCKTON LLP, 11130 SUNRISE VALLEY DRIVE, SUITE 300, RESTON, VA, 20191-4329, US

(21) Appl. No.: 09/682,288

(22) Filed: Aug. 14, 2001

Related U.S. Application Data
(60) Provisional application No. 60/225,611, filed on Aug. 15, 2000.
(60) Provisional application No. 60/242,625, filed on Oct. 23, 2000.

(51) Int. Cl. G06F 17/60

(52) U.S. Cl. 705/1

(57) ABSTRACT

A short-range radio transmitter establishes a link to a portable digital device (user device) within the transmitters range and transmits a universal resource locator (URL) to the device. As the user device receives the transmission, software is launched, and the software requests information from the transmitted URL via a different radio frequency link. The present invention allows individuals and businesses to install short-range radio transmitters in specific locations and cause a user device within a definable range to automatically display relevant information associated with that location. The information includes advertising, product, equipment, inventory, online payment processing, and information relating to any additional field.

### CROSS REFERENCE TO RELATED APPLICATIONS

This application claims priority to U.S. Provisional Application No. 60/225,611 filed Aug. 15, 2000 and U.S. Provisional Application No. 60/242,625 filed Oct. 23, 2000, each of which are expressly incorporated by reference herein in their entireties

### BACKGROUND OF INVENTION

The present invention relates generally to apparatus and methods utilizing a radio frequency (RF) link between a preprogrammed transmitter and a portable digital device (user devices), such as a portable computer, digital mobile phone or personal digital assistant. A universal resource locator (URL) is transmitted to such a user device. The transmission of the URL causes an appropriate software program to be executed on the user device. This software program will in turn launch the appropriate software program, such as an Internet Browser or Micro Browser, and pass or transmit the URL so that the appropriate information may be loaded from that URL through another RF link, such as a digital mobile telephone network.

The present invention is amenable to any number of different applications in which locale-based information is desirably received or exchanged based on the recipient's proximate presence. Examples of suited uses can be found in varying arenas including advertising, product information, online payment processing, equipment tracking and identification, and warehouse management.

The present invention further provides a person who physically approaches a locale, information about that specific locale, or product or service that is situated in the locale.

### SUMMARY OF INVENTION

The present invention provides systems and methods for receiving and exchanging information based on a user's proximate presence. In one embodiment, the method of the present invention requires locating a transmitter in an area frequented by persons potentially desirous of information related to the locale. The transmitter broadcasts a universal resource locator (URL) which is received by a user device carried by such persons desirous of the locale related information. The user device then initiates an inquiry based on the URL, to an information database. The information database receives the URL from the portable user device and sends information related to the locale back to the user device. The user views the information from the database using the portable digital device.

In an alternative embodiment of the present invention, the transmitter comprises a programmable radio frequency transmitter and the user device comprises a portable computer, digital mobile phone, personal digital assistant, or any other portable digital device.

The user device includes software which is able to interpret a radio frequency transmission, translate the radio frequency transmission into the URL, launch additional software programs on the user device, retrieve information represented by the URL, store information, and handle and transmit information over a secondary radio frequency link.

Locale information desired by a user may include advertising, product, transaction, online payment processing, equipment tracking, identification, warehouse management, and any additional information related to a specific locale.

### BRIEF DESCRIPTION OF DRAWINGS

The invention will now be described in greater detail in the following way of example only and with reference to the attached drawings, in which:

FIG. 1 is a flow-chart illustrating functional details of one embodiment of a system in which locale-based information is received or exchanged based on a recipient's proximate presence;

FIG. 2 is a functional block diagram illustrating several components of a transmission device utilized in the system of the present invention;

FIG. 3 is a flow-chart illustrating operational aspects of an exemplary transmission device;

FIG. 4 is a flow-chart illustrating operational aspects of software in a recipient's device; and

FIG. 5 is a flow-chart illustrating operational aspects of a server module of the present invention.

### DETAILED DESCRIPTION

As required, detailed embodiments of the present invention are disclosed herein; however, it is to be understood that the disclosed embodiments are merely exemplary of the invention that may be embodied in various and alternative forms. Specific structural and functional disclosed herein are not to be interpreted as limiting, but merely as a basis for the claims and as a representative basis for teaching one skilled in the art to variously employ the present invention.

In one embodiment, the present invention utilizes a short range radio frequency device placed in a specific location to provide the user of a hand-held unit, such as a digital mobile phone, personal digital assistant or a portable computer, with information relevant to the user's specific location.

The present invention includes the utilization of a radio frequency (RF) link between a programmable transmitter (permanently or volatilely) and a portable digital device (user devices), such as a portable computer, digital mobile phone or a personal digital assistant, across which a universal resource locator (URL) is transmitted from the transmitter to the user device. The systems, methods, programs, and processes described in relation to the present invention are not limited to any particular user device. The user device may be a single device, or it may be a plurality of devices working in concert. The transmission will cause the execution of a software program on the user device. This software program will in turn launch the appropriate software program, such as an Internet browser or micro browser, and pass the URL so that the appropriate information may be loaded from that URL through another RF link, such as a digital mobile telephone network.

In one embodiment, the invention includes a programmable RF transmitter and software which is contained within the user device. In this context, two different types of RF transmitters may be utilized in the invention. The transmitter may either consist of a standalone unit, in which case the URL will be preprogrammed and stored in non-volatile random access memory (NVRAM), or connected to another central processing unit (CPU), in which case the CPU will supply the RF transmitter with the URL.

The software contained within the user device may perform one or more of the following functions: (1) interpret the RF transmission received and translate it into a URL; (2) launch other software programs, on the user device, that retrieve the information represented by the URL over a secondary RF link; (3) securely store sensitive information such as credit card details, user names and passwords; (4) add stored information to responses over the secondary RF link; and (5) handle the retrieval and transmission of information over the secondary RF link.

Typically, the user device will have the hardware components required to handle the two RF links already installed. Alternatively, appropriate modifications may be required to accommodate the functions described herein.

A server may be connected to the user device through a combination of wired and/or RF links, the links being public or private. Private links include a wireless local area network (LAN), a wide area network (WAN), and an internal Ethernet. Public links may include a digital mobile phone network and the Internet, or any combination of the same. The server may also be directly or indirectly connected to the RF transmitters from which the URL originates.

The server contains software which is operable for receiving the URL, performing processing and communication with other systems (such as those used in credit card authorization), and returning the information identified by the URL to the user device. Connected CPUs and RF transmitters may be notified as a result of the processing. The server may be a persistent storage device, such as an application server, a web server, a file server, or a database server. The system may be set-up such that the server may communicate information to and acquire information from a plurality of remote users simultaneously.

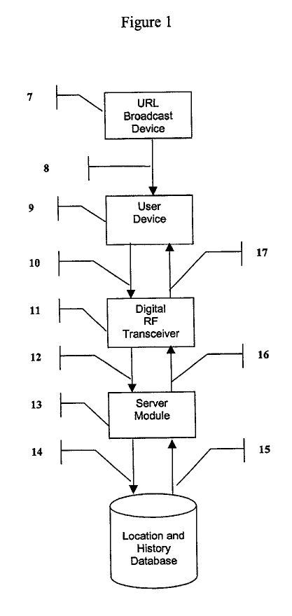

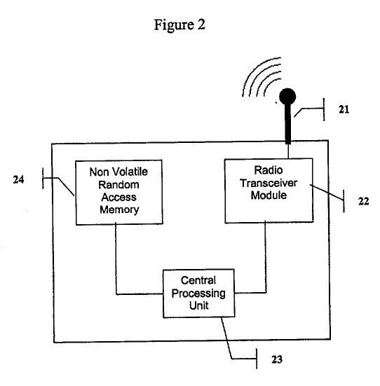

Aspects of certain embodiments of the invention are illustrated in the accompanying figures. An overview of the components of the system are found in FIG. 1. The URL broadcast device (7 and FIG. 2) consists of a non-volatile random access memory unit (24) that is preprogrammed with a URL, a universal resource identifier (URI), or a string, such as an Internet protocol (IP) address, that will allow any user device with a connection to the Internet to access the relevant information.

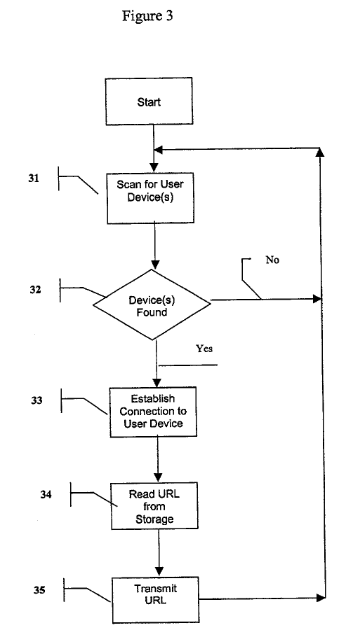

The CPU of the URL broadcast device (23) interfaces with the non-volatile RAM unit (24) and a radio transceiver module (22), and is operable for performing the operations outlined in FIG. 3. The CPU may be, for example, a microprocessor. Suitable examples of microprocessors include, but are not limited to, those manufactured by Advanced Micro Devices, Inc. (Sunnyvale, Calif.), Intel Corporation (Santa Clara, Calif.), Motorola, Inc. (Schaumberg, Ill.), International Business Machines Corp. (Armonk, N.Y.), and Transmeta Corp. (Santa Clara, Calif.).

The radio transceiver module (22) may include any industry standard digital transmission protocol such as Bluetooth™ (Motorola, Inc.), IEEE 802.11 b (The Institute of Electrical and Electronics Engineers), or similar, and is connected to an antenna (21). The “Bluetooth” protocol defines a universal radio interface in the 2.45 GHz frequency band that enables wireless electronic devices to connect and communicate wirelessly via short-range, ad hoc networks.

After the URL broadcaster module has scanned and connected to a compatible device (31 33), the module reads the URL (34) from the non-volatile RAM unit (24) and transmits the URL to the user's device. (35 and 8).

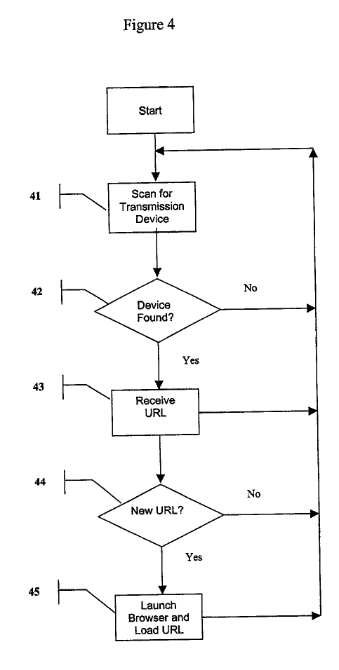

The user device (9) will then execute the operation as outlined in the flow chart in FIG. 4. The user device is constantly scanning for a compatible unit (41), and when a device is found (42), the user device will receive the URL (43). The software will then determine whether or not the URL received was new or the same as a previously loaded URL (44). If the URL is determined to be new, the software adds a unique identifier and loads the page (45 and 10) by establishing a secondary digital RF link (11). It should be noted that the secondary digital RF link may be handled by the public telephone network, a wireless local area network (WLAN), or through a secondary link to the URL broadcaster module, should this device be linked to the Internet.

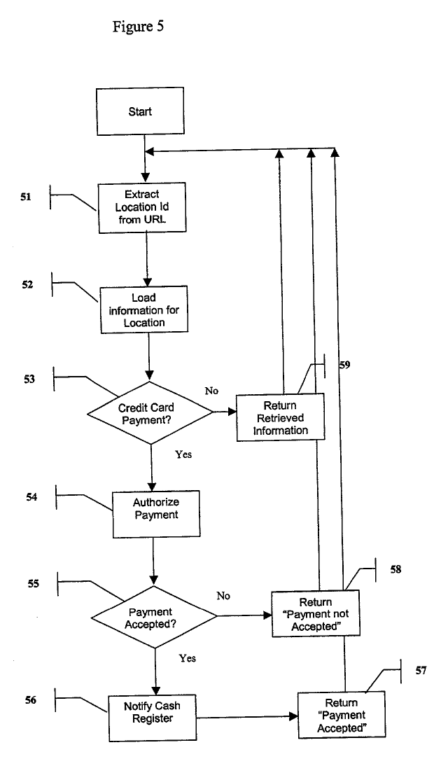

A secondary digital transceiver (11) will request the information (12) from the server identified by the URL. A server module (13) will then perform the operations outlined in the flow-chart in FIG. 5. The server module will first extract the location identification from the URL (51), and then request the information associated with the location from permanent storage (52, 14, 15). The server module will then determine whether or not the location is a payment location (53). If the location is not determined to be a payment location, and the current transaction is not a payment transaction, the information may be personalized according to the user's preferences (59) and sent back to the user's device via the previously established secondary digital RF link (15 17).

If the location is determined to be a payment location, and the transaction is a payment transaction (53), the server module will authorize the payment (54) as a credit card transaction. If the payment is not authorized (55), a message indicating that payment was not accepted will be sent back to the client device via the secondary digital RF link previously established (58 and 15 17). If the payment was accepted (55), the server module will notify the cash register (56) and the client device (57) that the payment was accepted.

The methods and systems of the present invention are amenable to any number of different applications in which locale-based information is desirably received or exchanged based on the user's proximate presence. The present invention may be implemented in advertising, where a merchant may place a transmitter inside the entrance of a business establishment that immediately causes a consumer's personal communication device to load information about a store's special offers upon entrance. A merchant may place a transmitter(s) in strategic positions within an establishment so that the user/customer can either selectively or automatically receive information about products and services offered in proximity of the transmitter.

A transmitter may be connected to a checkout device, such as a cash-register, and may transmit a URL to the user device, allowing the user device to download information related to the transaction being accomplished through the secondary RF link. The user may then choose to transmit, over the secure secondary RF link, previously stored credit card details as a response to the request. Server software may then authorize the credit-card charge and notify the checkout device if the authorization was or was not successful.

The present invention allows for businesses to track and service various types of equipment and machinery by attaching a transmitter to the equipment. When maintenance personnel are in the vicinity of the equipment, their user device may automatically download relevant information relating to the equipment, and the information may be used for diagnostics, repair procedures, and any other information desired by the user.

The present invention aids in warehouse management by allowing an operator to equip product shelves in a warehouse, or similar setting, with an RF transmitter(s) that enables personnel in the warehouse to retrieve information related to stock quantity, price, expected deliveries and the like, by positioning their user device within reception range of the transmitter.

The present invention may be advantageously employed in any location in which it is expected that a user desiring knowledge related to a particular locale, or product or service situated in the locale, will have a physical presence in the locale.

Methods and systems for information dissemination have been described herein. These, and other variations, which will be appreciated by those skilled in the art, are within the intended scope of this invention as claimed below. As previously stated, detailed embodiments of the present invention are disclosed herein; however, it is to be understood that the disclosed embodiments are merely exemplary of the invention that may be embodied in various forms.

1. A method for disseminating information related to a locale, the method comprising:
locating a transmitter in an area frequented by persons potentially desirous of information related to the locale;
broadcasting a universal resource locator (URL) capable of being received by a user device carried by such persons;
receiving the URL at the user device;
initiating an inquiry by the user device to an information database; and
receiving information from the information database related to the locale.

2. The method of claim 1, wherein the transmitter comprises a programmable radio frequency transmitter.

3. The method of claim 1, wherein the user device comprises a portable computer, digital mobile phone, personal digital assistant, or any other portable digital device.

4. The method of claim 1, wherein the user device comprises software operable for interpreting a radio frequency transmission, translating the radio frequency transmission into a URL, launching additional software programs on the user device, retrieving information represented by the URL, storing information, and handling and transmitting information over a secondary radio frequency link.

5. The method of claim 1, wherein the transmitter further comprises a preprogrammed non-volatile random access memory unit, a universal resource identifier (URI), or an Internet protocol (IP) address.

6. The method of claim 1, wherein the information database comprises an application server, a web server, a file server, or a database server.

7. The method of claim 1, wherein the information comprises advertising, product, transaction, online payment processing, equipment tracking, identification, warehouse management, and any additional information.

8. A system for disseminating information related to a locale, the system comprising:
a short-range radio transmitter, located in an area frequented by persons potentially desirous of information related to the locale, operable for broadcasting a universal resource locator (URL)
a user device carried by such persons operable for receiving the URL; and
an information database operable for receiving/sending locale related information to/from the user device.

9. The method of claim 8, wherein the transmitter comprises a programmable radio frequency transmitter.

10. The method of claim 8, wherein the user device comprises a portable computer, digital mobile phone, personal digital assistant, or any other portable digital device.

11. The method of claim 8, wherein the user device comprises software operable for interpreting a radio frequency transmission, translating the radio frequency transmission into a URL, launching additional software programs on the user device, retrieving information represented by the URL, storing information, and handling and transmitting information over a secondary radio frequency link.

12. The method of claim 8, wherein the transmitter further comprises a preprogrammed non-volatile random access memory unit, a universal resource identifier (URI), or an Internet protocol (IP) address.

13. The method of claim 8, wherein the information database comprises an application server, a web server, a file server, or a database server.

14. The method of claim 1, wherein the information comprises advertising, product, transaction, online payment processing, equipment tracking, identification, warehouse management, and any additional information.
